(19) United States
(12) Patent Application Publication
(10) Pub. No.: US 2021/0397384 A1
(43) Pub. Date: Dec. 23, 2021

(54) VIDEO SYSTEM, TERMINAL, AND MOTION DEVICE

(71) Applicant: TOSHIBA TEC KABUSHIKI KAISHA, Tokyo (JP)

(72) Inventor: Futoshi MORI, Mishima Shizuoka (JP)

(21) Appl. No.: 17/465,175

(22) Filed: Sep. 2, 2021

Related U.S. Application Data
(63) Continuation of application No. 16/832,374, filed on Mar. 27, 2020.

(30) Foreign Application Priority Data
Jun. 14, 2019 (JP) 2019-111425

(51) Int. Cl. G06F 3/12

(52) U.S. Cl. CPC G06F 3/121; G06K 15/022; G06F 3/1234

(57) ABSTRACT

A video system according to an embodiment includes a first device for generating signals corresponding to an error state of the first device. The signals identify error types and stages in an operation for clearing the error state experienced by the first device. A video image display screen is provided to display video images related to the error state. A second device is communicably connected to the first device to receive the signals from the first device and then supply the video images related to the error state to the video image display screen according to error type and stage in the operation for clearing the error state as indicted by the signal.

### CROSS-REFERENCE TO RELATED APPLICATIONS

This application is a continuation of U.S. patent application Ser. No. 16/832,374, filed on Mar. 27, 2020, which is based upon and claims the benefit of priority from Japanese Patent Application No. 2019-111425, filed on Jun. 14, 2019, the entire contents of each of which are incorporated herein by reference.

### FIELD

The present disclosure relates to a video system, a terminal, and a motion device.

### BACKGROUND

When an error occurs in a printer during the printing of information on a sheet, a label, or a receipt, a message indicating a method for correcting the error is displayed by the printer on a display unit. However, the method for correcting the error may be complicated, and it may be difficult for a user to understand the error correction process based only on the information/message provided on display unit.

As one means of overcoming this problem, it may be more effective to provide the user a video or the like for explaining the method for correcting the printer error, but, in general, a large capacity memory would have to be provided in the printer for storing such videos, which is not practical for many printers, particularly inexpensive printers.

### BRIEF DESCRIPTION OF THE DRAWINGS

FIG. 1 is a diagram showing a video system according to a first embodiment.

FIG. 2 is a block diagram showing a hardware configuration of a printer.

FIG. 3 is a block diagram showing the hardware configuration of a terminal.

FIG. 4 is a block diagram showing a hardware configuration of a video server.

FIG. 5 is a memory map showing the structure of the video data section.

FIG. 6 is a functional block diagram of a video system.

FIG. 7 is a flow chart of a control process of a printer.

FIG. 8 is a flowchart of control processing of a printer relating to error processing.

FIG. 9 is a flowchart of a terminal control process.

FIG. 10 is a flowchart showing a control process of a video server.

FIG. 11 is a flowchart of a terminal control process according to a modification example of the first embodiment.

FIG. 12 is a flowchart showing a flow of the control process of a video server according to the modification example of the first embodiment.

FIG. 13 is a diagram showing a video system according to a second embodiment.

FIG. 14 is a block diagram showing a hardware configuration of a printer according to a second embodiment.

FIG. 15 is a functional block of a video system according to a second embodiment.

FIG. 16 is a flowchart of control processing of a printer related to error processing according to a second embodiment.

FIG. 17 is a flowchart of a control process of a video server according to a second embodiment.

### DETAILED DESCRIPTION

Embodiments provide a video system, a terminal and a motion device capable of displaying a method for canceling an error without mounting a large capacity memory on a printer.

According to one embodiment, a video system includes a first device for generating signals corresponding to an error state of the first device. The signals identify error types and stages in an operation for clearing the error state. A video image display screen is provided to display video images related to the error state. A second device is communicably connected to the first device to receive the signals from the first device and supply the video images related to the error state to the video image display screen according to error type and stage in the operation for clearing the error state.

### First Embodiment

In an example embodiment, a receipt printer used for printing information on a continuous sheet of paper (or a roll of paper) will be described. The receipt printer is one possible an example of a device with moving parts (a motion device) or the like. It should be noted that the present disclosure is not limited to the specific example embodiments described.

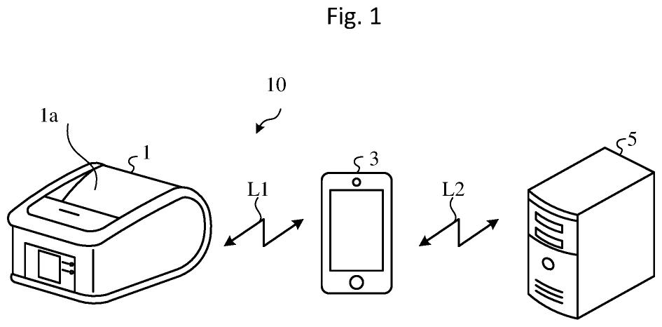

FIG. 1 is a diagram showing a video system according to a first embodiment. As shown in FIG. 1, the video system 10 includes a printer 1 and a terminal 3. A video server 5 is connected to the video system 10. The printer 1 and the terminal 3 are connected to each other by communication line L1 using NFC (Near Field Communication), for example. The terminal 3 and the video server 5 are connected to each other such that they can communicate with each other by communication line L2, which is a connection such as a wireless LAN (Local Area Network), for example.

The printer 1 is a small-sized, lightweight printer which is worn on the waist of an operator, for example. The printer 1 is used, for example, for inventory management in a warehouse or for issuance of meter reading receipts/logs such as for residential utilities such as electric or gas.

The printer 1 accommodates a roll of paper (a paper roll). The printer 1 is provided with a cover 1a that can be opened and closed to permit access and replacement of the paper roll. The paper is composed of, for example, thermal paper. The printer 1 includes a print section including a print head including heat generating elements arranged in a line shape. The print section prints and issues information to the conveyed paper.

To store the paper roll in the printer 1, the cover 1a is opened, the paper roll is inserted, and the cover 1a is then closed. The printer 1 performs printing on the paper drawn/supplied from the paper roll using the print section.

When the paper roll stored in the printer 1 is finished, the printer 1 outputs a paper end signal (one of the error signals). The operator opens the cover 1a of the printer 1 to insert the new paper roll, and then closes the cover 1a.

When an error occurs, the printer 1 transmits an error signal indicating that an error has occurred. The printer 1 also transmits a step signal indicating the step/stage in the error correction processing, if any, that has already been performed to the terminal 3 via the communication line L1. The error signal and step signal corresponds to a signal for instructing the display of a video image. The error signal and the stage signal include information indicating the type of error (e.g., supply an error number). The number of steps to be completed (and thus indicated by the step signal) can be different depending on the type of error, and the different stage signals are transmitted in sequence upon completion of the respective step. For example, in the case of a paper end error, the paper end signal (error signal) is first transmitted, and then the respective stage signals are transmitted upon completion of the related error correction steps. Specifically, printer 1 first transmits a paper end signal indicating a paper end, then transmits a first stage signal when the paper roll is replenished, and transmits a second stage signal once the cover 1a is closed after paper has been refilled. The second stage signal is sent to terminal 3. Since the paper end signal, the first stage signal and the second stage signal are each different stage signals, the terminal 3 can distinguish between the paper end signal, the first stage signal, and the second stage signal.

The terminal 3 may be, for example, a mobile phone, a smartphone, a tablet terminal, a PDA (Personal Digital Assistant), or the like. Terminal 3 stores video image information for correcting an error in printer 1. When receiving an error signal from the printer 1, the terminal 3 transmits the error signal (including the error number) to the video server 5 via the communication line L2. The terminal 3 receives and stores the video image information related to the various common errors of the printer 1 received from the video server 5. The video image information that is received from the video server 5 includes information about the videos for each of the steps (release steps) the operator's process for correction of the particular error in the printer 1.

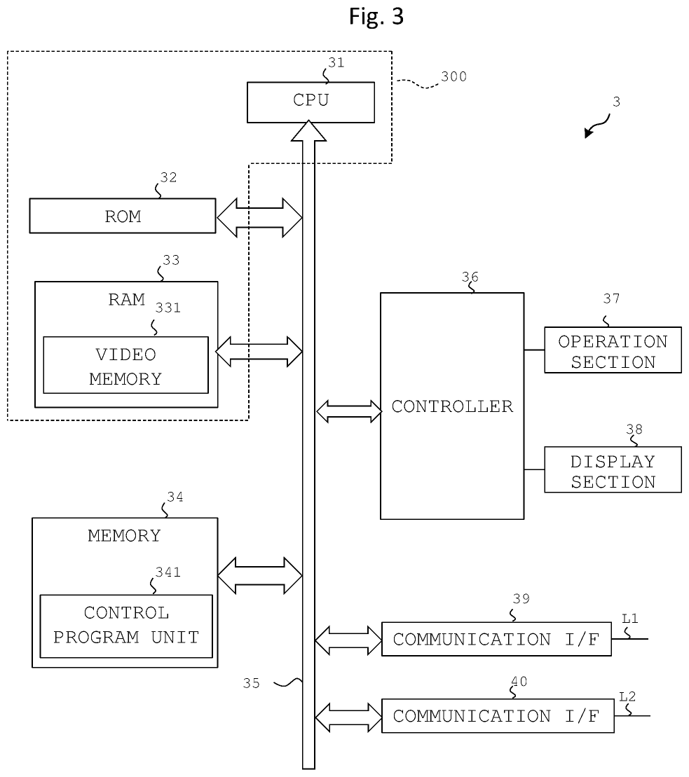

The terminal 3 displays the video for each release step on the display section 38 (refer to FIG. 3) according to the error signal that has been received. When the terminal 3 receives the next stage signal, it displays the video corresponding to this stage signal on the display section 38 from the stored video image information.

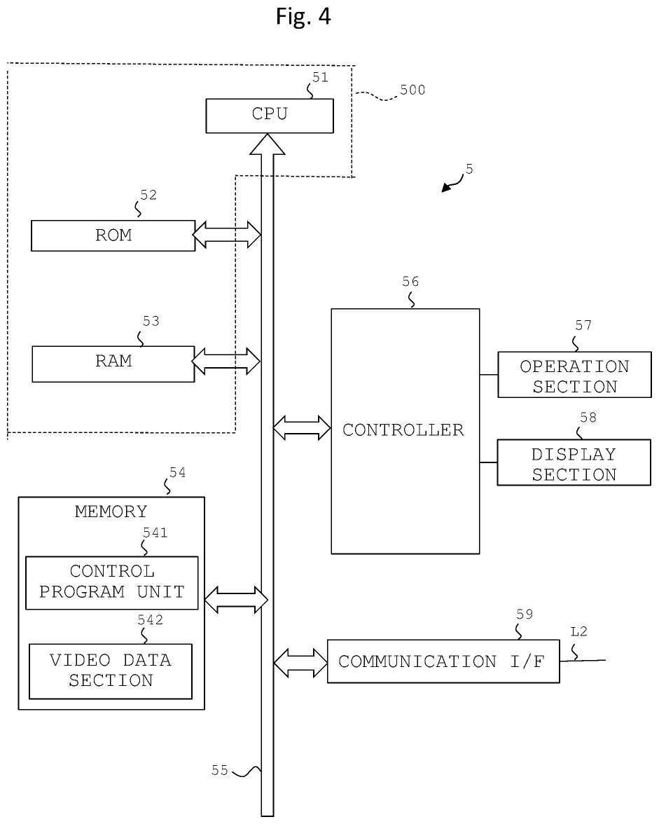

The video server 5 stores, in association with the video data section 542 (see FIG. 4), video data section (see FIG. 1), which indicates the procedure for releasing the errors associated with the errors occurring in the printer 1. When the video server 5 receives the error signal and information for requesting the distribution of the video image from the terminal 3, the video server 1 identifies the type of the error based on the error number included in the error signal. Then, the video server 5 transmits, to the terminal 3, the video image information indicating that the release step is to be performed for the release of the error associated with the specified error.

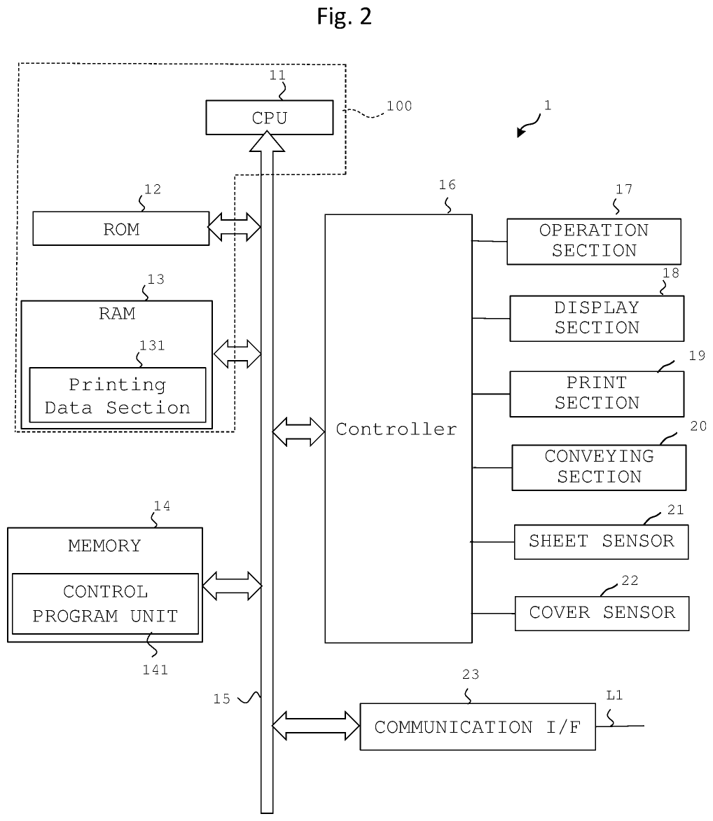

The hardware of the printer 1 will now be described. FIG. 2 is a block diagram showing a hardware configuration of the printer 1. As shown in FIG. 2, the printer 1 includes a CPU (Central Processing Unit) 11, a ROM (Read Only Memory) 12, a RAM (Random Access Memory) 13, a memory 14, and the like. The CPU serves as a control subject. The ROM 12 stores various programs. The RAM 13 develops programs and various kinds of data. The memory 14 stores various programs. The CPU 11, the ROM 12, the RAM 13, and the memory 14 are connected to each other via a BUS 15. The CPU 11, the ROM 12, and the RAM 13 constitute a control section 100. That is, the control section 100 executes the control processing of the printer 1 described later by operating the CPU 11 in accordance with the control program stored in the ROM 12 and the memory 14 and expanded in the RAM 13.

The RAM 13 includes a printing data section 131. The printing data section 131 stores information to be printed on a paper sheet.

The memory 14 is composed of a solid state drive (SSD), a hard disc drive (HDD), a flash memory, and the like, and maintains the stored contents even when the power supply is shut off. The memory 14 includes a control program unit 141. The control program unit 141 stores a control program for controlling printer 1.

The control section 100 includes an operation section 17, a display section 18, a print section 19, a conveying section 20, a sheet sensor 21, and a cover sensor 22 via a BUS 15 and a controller 16. The operation section 17 is a key for operating the printer 1. The display section 18 displays information to an operator who operates the printer 1. The print section 19 prints information stored in the printing data section 131 on the conveyed paper sheet. The conveying section 20 draws paper from the paper roll and conveys the paper to the print section 19. The sheet sensor 21 is a sensor to detect the presence or absence of paper. When the sheet sensor 21 detects no paper, the control section 100 determines that the paper is at an end (finished). The cover sensor 22 detects the open state of the cover 1a and the closed state of the cover 1a.

The control section 100 is connected to the communication I/F 23 via the BUS 15. The communication I/F 23 can transmit and receive information to and from the terminal 3 via the communication line L1.

The hardware of the terminal 3 will now be described. FIG. is a block diagram showing the hardware configuration of terminal 3. As shown in FIG. 3, the terminal 3 includes a CPU 31, a ROM 32, a RAM 33, a memory 34, and the like. The CPU 31 serves as a control subject. The ROM 32 stores various programs. The RAM 33 develops programs and various kinds of data. The memory 34 stores various programs. The CPU 31, the ROM 32, the RAM 33, and the memory 34 are connected to each other via a BUS 35. The CPU 31, the ROM 32, and the RAM 33 constitute a control section 300. That is, the control section 300 executes the control processing of terminal 3 described later by operating the CPU 31 according to the control program stored in the ROM 32 and the memory 34 and expanded in the RAM 33.

The RAM 33 is provided with a video memory 331. The video memory 331 stores video image information, which is received from the video server 5 and which is indicative of the procedure for canceling the error generated in the printer 1, in accordance with the plurality of release steps.

The memory 34 is constituted by an SSD, an HDD, a flash memory, and the like, and maintains the stored contents even when the power supply is shut off. The memory 34 includes a control program unit 341. The control program unit 341 stores a control program for controlling the light transmittance detector 3.

The control section 300 includes an operation section 37 and a display section 38 via a BUS 35 and a controller 36. The operation section 37 is a key for operating the terminal 3. The display section 18 displays information to the operator who operates the terminal 3. The display section 18 displays video images related to video image information stored in the video memory 331.

The control section 300 is connected to the communication I/F 39 via the BUS 35. The communication I/F 39 is capable of transmitting/receiving information to/from the printer 1 via the communication line L1. The control section 300 is connected to the communication I/F 40 via the BUS 35. The communication I/F 40 can transmit and receive information to and from the video server 5 via the communication line L2.

The hardware of the video server 5 will now be described. FIG. 4 is a block diagram showing a hardware configuration of the video server 5. As shown in FIG. 4, the video server 5 includes a CPU 51, a ROM 52, a RAM 53, a memory 54, and the like. The CPU 51 serves as a control subject. The ROM 52 stores various programs. The RAM 53 develops programs and various kinds of data. The memory 54 stores various programs. The CPU 51, the ROM 52, the RAM 53, and the memory 54 are connected to each other via a BUS 55. The CPU 51, the ROM 52, and the RAM 53 constitute a control section 500. That is, the control section 500 executes the control processing of the video server 5 described later by operating the CPU 51 according to the control program stored in the ROM 52 and the memory 54 and expanded in the RAM 53.

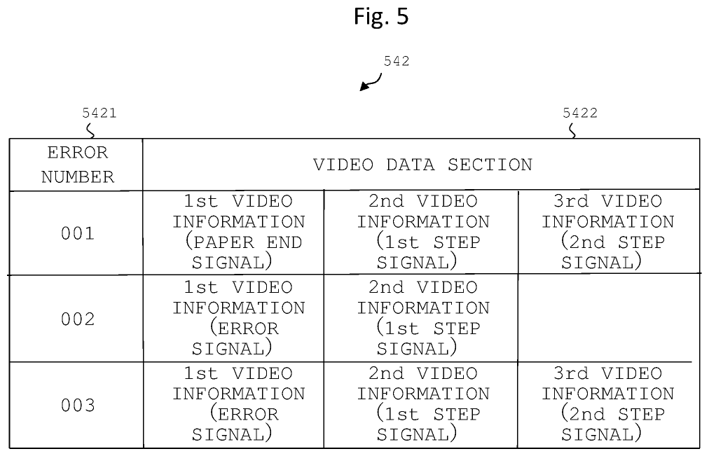

The memory 54 is constituted by an SSD, an HDD, a flash memory, and the like, and maintains the stored contents even when the power supply is shut off. The memory 54 includes a control program unit 541 and a video data section 542. The control program unit 541 stores a control program for controlling video server 5. The video data section 542 stores video image information that indicates the procedure of canceling the error in stages corresponding to the release step of the error, for all errors that may occur in the printer 1. The video data section 542 will be described later in detail with reference to FIG. 5.

The control section 500 is connected to the communication I/F 52 via the BUS 55 and the BUS 9. The communication I/F 9 can transmit and receive information to and from the terminal 3 via the communication line L2.

Next, the video data section 542 will be described. The video data section 542 stores video image information that indicates the procedure of canceling the error in stages corresponding to the release step of the error, for all errors that may occur in the printer 1. FIG. 5 is a memory map showing the configuration of the video data section 542. The video data section 542 includes an error number section 5421 and a step video store section 5422. The error number section 5421 stores an error number for identifying the type of error. The step video store section 5422 stores the procedure for canceling the error in association with the error number stored in the error number section 5421 for each stage signal in accordance with the release step. For example, the step video store section 5422 stores a first video image associated with a paper end signal which is one of the step signals, a second video image associated with the first stage signal, and a first video image associated with the second stage signal for a paper end error having an error number of “3”. In addition, the step video store section 5422 stores the second video image associated with the error signal and the first video image associated with the first stage signal for an error of the error number “002”. In addition, the step video store section 5422 stores, for an error of the error number “003”, a first video image associated with the error signal, a second video image associated with the first stage signal, and a third video image associated with the second stage signal. The step video store section 5422 stores the video image for each stage signal for other errors.

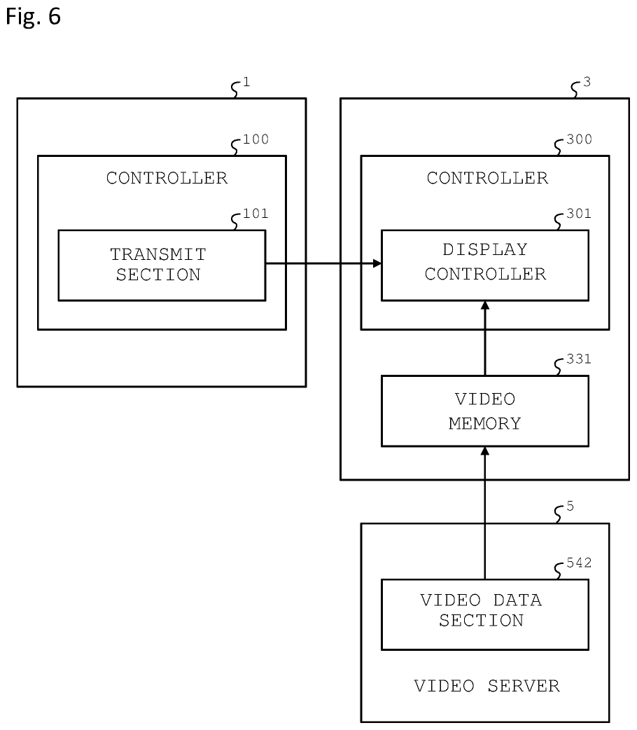

The functional configuration of the video system 10 will now be described. Specifically, the functional configuration of the printer 1 and the functional configuration of the terminal 3 will be described. FIG. 6 is a functional block diagram showing a functional configuration of the video system 10. The control section 100 of the printer 1 is stored in the control program section 141, and functions as a transmit section 101 by following the control program stored in the RAM 13.

The transmit section 101 transmits to the terminal 3 a signal instructing the display of the video image of the plurality of release steps including the type of the error that has occurred. Specifically, when an error occurs in the printer 1, the transmit section 101 transmits a signal (a phase signal including an error signal) to the terminal 3 to display the video image of the plurality of release steps.

The control section 300 of the terminal 3 is stored in the control program section 341, and functions as the display control section 301 by following the control program stored in the RAM 33.

Each time the display control section 301 receives the error signal and the step signal from the printer 1, the display control section 102 displays a video image based on the video image information corresponding to a signal instructing the display of the video image at the received stage corresponding to the type of the error. Specifically, when the display control section 301 receives an error signal from the printer 1, the display control section 102 receives video image information related to the error from the video image information for canceling an error stored in the video data section 542 of the video server 5, and stores the received video image information in the video memory 331. The display control section 301 displays a video image based on video image information corresponding to an error signal from the video image information stored in the video memory 331. When receiving the step signal from the printer 1, the display control section 301 displays a video image based on the video image information corresponding to the step signal, based on the video image information stored in the video memory 331.

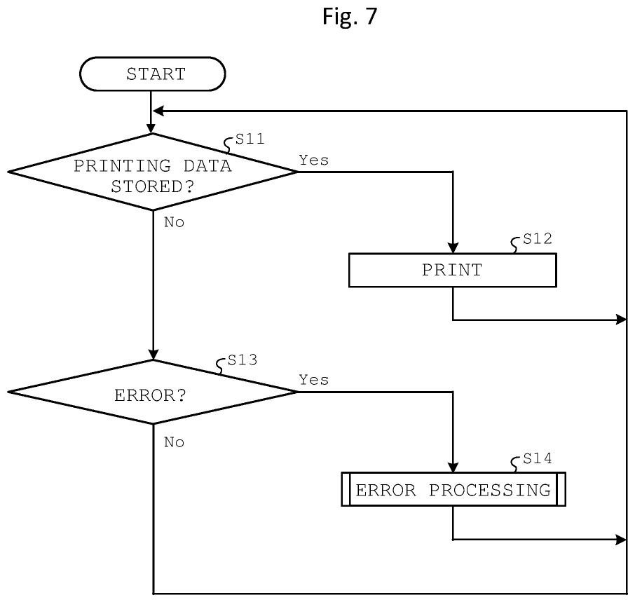

The control of the printer 1 will now be described. FIG. 7 is a flowchart showing a flow of control processing performed by the printer 1. As shown in FIG. 7, the control section 100 of printer 1 determines whether information to be printed is stored in printing data section 131 (S11). The information to be printed is received from a PC (Personal Computer) which is a master unit capable of communicating with, for example, printer 1. When it is determined that information to be printed is stored in the printing data section 131 (Yes in S11), the control section 100 drives the print section 19 to print information stored in the printing data section 131 on the paper (S12). Then, the control section 100 returns to S11.

When it is determined that the information to be printed is not stored in the printing data section 131 (No in S11), the control section 100 determines whether or not an error has occurred in printer 1 (S13). The control section 100 determines whether an error has occurred in the printer 1 based on the output from the various sensors provided in the printer 1. When it is determined that an error has occurred in the printer 1 (Yes in S13), the control section 100 executes error processing for the error in order to cancel the generated error (S14). Then, the control section 100 returns to S11.

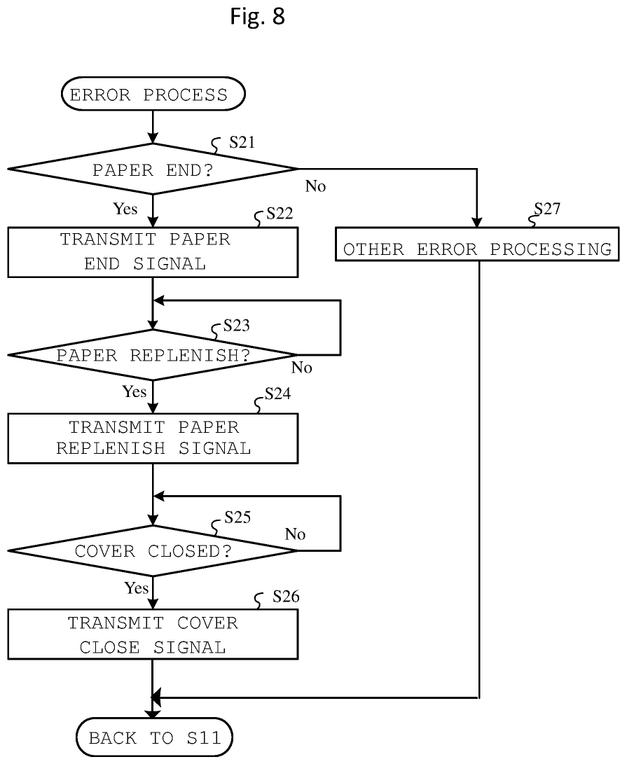

FIG. 8 is a flowchart of the control process of the printer 1 relating to the error processing to be processed in the step S14. In FIG. 8, a description will be given as an example of the processing of the paper end in the case where the paper stored in the printer 1 is lost. The control section 100 determines whether or not the error that has occurred is an error in the paper end (S21). When sheet sensor 21 outputs an output that has detected no paper, control section 100 determines that the error that has occurred is an error in the paper end. When it is determined that the generated error is an error in the paper end (Yes in S21), the transmit section 101 transmits a paper end signal (error signal), which is a stage signal including an error number for specifying the type of the error that has occurred, to the terminal 3 (S22).

Next, the control section 100 determines whether or not the paper is replenished to the printer 1 (S23). When the sheet sensor 21 detects the presence of the sheet sensor 1, the control section 100 determines that the sheet has been replenished. When it is determined that the paper is replenished (No in S23) and the paper is replenished (Yes in S23), the transmit section 101 transmits the paper replenishment signal (first stage signal) including the error number for specifying the type of the error that has occurred to the terminal 3 (S24).

Next, the control section 100 determines whether or not the cover 1a is closed (S25). When cover 1a is closed and cover sensor 22 outputs an output that detects closure of cover 1a, control section 100 determines that cover 1a has been closed. When it is determined that the cover 1a is closed (No in S25) and the cover 1a is closed (Yes in S25), the transmit section 101 transmits a cover closing signal (second stage signal) including the error number for specifying the type of the error that has occurred, to the terminal 3 (S26). Then, the control section 100 returns to S11.

When it is determined in S21 that the error is not an error in the paper end (No in S21), the control section 100 executes error processing for other errors. Then, the control section 100 returns to S11.

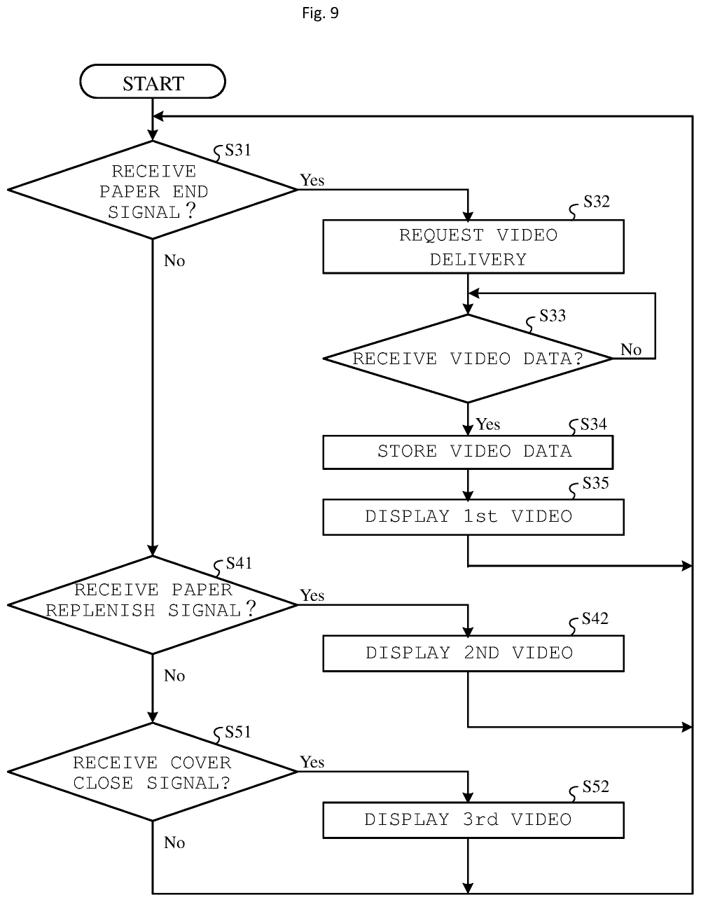

The control of the terminal 3 will now be described. FIG. 9 is a flowchart the control processing of terminal 3. As shown in FIG. 9, the control section 300 of the terminal 3 determines whether or not the sheet end signal transmitted from the printer 1 has been received (S31). When it is determined that the paper end signal is received from the printer 1 (Yes in S31), the control section 300 transmits a signal requesting the video server 5 to distribute the paper end signal and video image information indicating the procedure of releasing the error in the paper end in steps (S32).

Next, the control section 300 determines whether or not the video server 5 has received the video image information corresponding to the request transmitted in S32 (S33). When it is determined in step S33 that the video image information for the request transmitted in S32 is received (No in S33), and when it is determined in S33 that the video image information for the request transmitted in S32 has been received, the control section 300 stores the received video image information in the video memory 331 in S34. The display control section 301 displays the first video image corresponding to the video image information of the release step corresponding to the paper end signal in the display section 38, out of the video image information stored in the video memory 331 (S35). The first video image is, for example, a video image which depicts opening of the cover 1a and suggests to the operator to supply a paper roll. Then, the control section 300 returns to S31.

When it is determined that the paper end signal has not been received from the printer 1 (No in S31), the control section 300 next determines whether the paper replenishment signal transmitted from the printer 1 has been received (S41). When the sheet replenishment signal has been received from the printer 1 (Yes in S41), the display control section 301 displays, on the display section 38, the second video image corresponding to the release step corresponding to the sheet replenishment signal from the video image information stored in the video memory 331 (S42). The second video image is, for example, a video for prompting the operator to close the cover 1a of the printer 1. After this, the control section 300 returns to S31.

When it is determined that the sheet replenishment signal from the printer 1 has not been received (No in S41), the control section 300 next determines whether the cover closing signal from the printer 1 has been received (S51). When the cover closing signal has been received from the printer 1 (Yes in S51), the display control section 301 displays, on the display section 38, a third video image corresponding to the video image information of the release step corresponding to the cover closing signal from the video image information stored in the video memory 331 (S52). The third video image is, for example, a video image for prompting or explaining a head indexing operation for advancing the paper to a predetermined position by operation of the operation section 17 of the printer 1. Then, the control section 300 returns to S31.

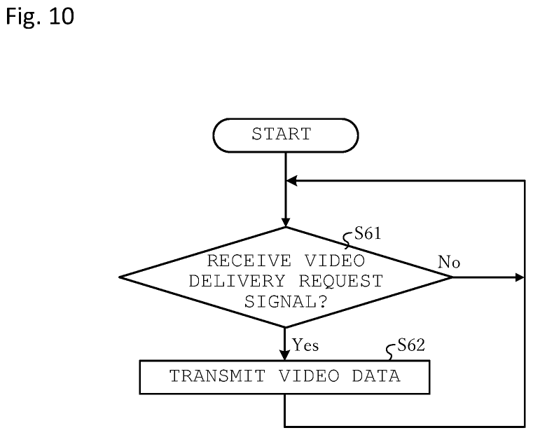

FIG. 10 is a flow chart of the control process performed by the video server 5. As shown in FIG. 10, the control section 500 of the video server 5 determines whether or not a signal requesting the distribution of the video image information related to the process of S32 is received from the terminal 3 (S61). When it is determined that the signal requesting the distribution of the video image information is yet to be received (No in S61), the control section 500 waits and when it is determined that the signal requesting the distribution of video image information has been received (Yes in S61), the control section 500 extracts all pieces of video image information for the error number associated with signal of the printer 1 (e.g., the received paper end signal) from the video data section 542, and transmits the extracted information to the terminal 3 in S62. For example, when the distribution of the video image information related to the error number “001” is requested, the control section 500 transmits the first video image, the second video image, and the third video image associated with the error number “001” extracted from the video data section 542 to the terminal 3 from which the request has been made. Then, the control section 500 returns to S61.

### A modification of the First Embodiment

In the first embodiment, when there is a request to distribute video image information in the process of S32, all of the video image information associated with the error number is transmitted to the terminal 3 at once. However, in the modified example, the video image information corresponding to the release step is transmitted to the terminal 3 in stages or parts based on the error information and the step information.

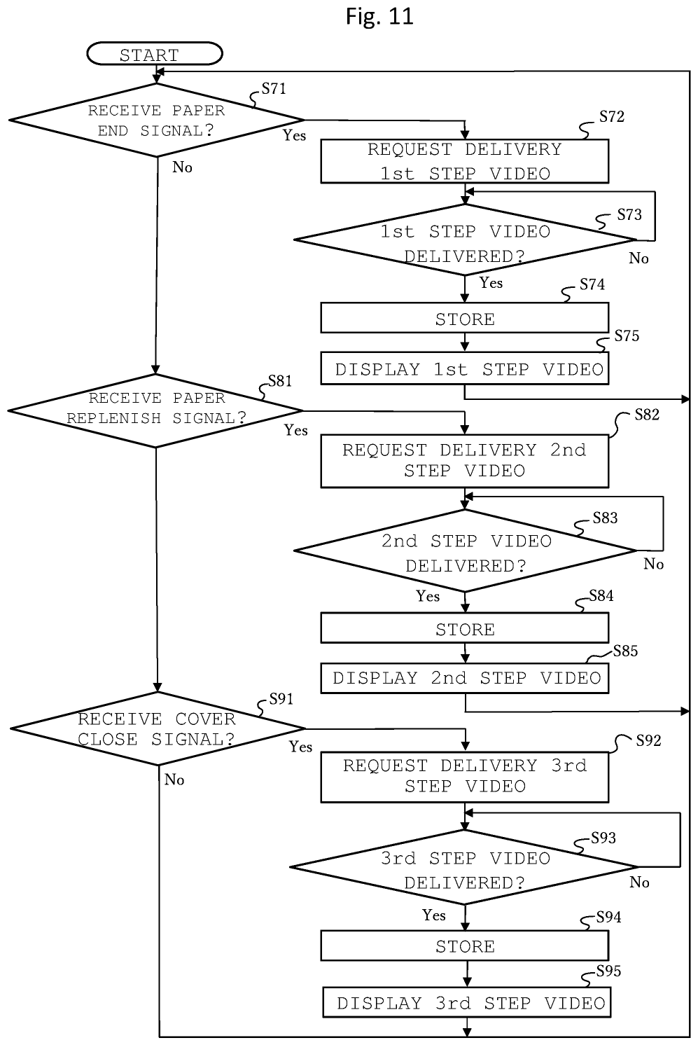

FIG. 11 is a flowchart showing a flow of the control processing of the terminal 3 according to the modification of the first embodiment. As shown in FIG. 11, the control section 300 determines whether the sheet end signal has been received from the printer 1 (S71). When it is determined that the paper end signal has been received from the printer 1 (Yes in S71), the control section 300 transmits a signal requesting the video server 5 to distribute the first step video image information related to the paper end signal (S72).

Next, the control section 300 determines whether first step video data for the request transmitted in S72 has been received from the video server 5 (S73). When it is determined that the first step video data is received (YES in S73), the control section 300 stores the received first step video data in the video memory 331 (step S74). Otherwise (that is, NO in S73), the control section 300 waits for the first step video data to be delivered. Then, the display control section 301 causes the first step video image corresponding to the first step video data stored in the video memory 331 to be displayed on the display section 38 (S75). The first step video image is, for example, a video image in which opening of the cover 1a of the printer 1 is indicated and that urges the operator to supply of a new paper roll. Then, the control section 300 returns to S31.

When the paper end signal has not been received from the printer 1 (No in S71), the control section 300 next determines whether the paper replenishment signal has been received or not from the printer 1 (S81). When it is determined that the paper replenishment signal has been received from the printer 1 (Yes in S81), the control section 300 transmits a signal requesting the video server 5 to deliver the second step video image information which explains or suggests a procedure for clearing the paper replenishment signal and associated possible error(s) (S82).

Next, the control section 300 determines whether the second step video data for the request transmitted in S82 has been received from the video server 5 (S83). When it is determined in S83 that the second step video data has not been received (NO in S83), the control section 300 waits until the second step video data is received. When the second step video data is received (Yes in S83), the control section 300 then stores the received second step video data in the video memory 331 (S84). Then, the display control section 301 displays, on the display section 38, the second step video image corresponding to the second step video data stored in the video memory 331 (S85). The second step video image is, for example, a video image for prompting to the operator to close the cover 1a of the printer 1. Then, the control section 300 returns to

S81.

When it is determined that the sheet replenishment signal from the printer 1 has not been received (No in S81), the control section 300 next determines whether the cover closing signal has been received from the printer 1 (S91). When it is determined that the cover closing signal has been received from the printer 1 (Yes in S91), the display control section 301 transmits to the video server 5 a signal requesting the video server 3 to deliver the third step video image information in the S92. The third step video image information indicates the procedure for clearing the cover closing signal and associated error(s).

Next, the control section 300 determines whether or not the third step video data has been received from the video server (S93). When it is determined that the third step video data has not yet been received (No in step 93), the control section 300 waits until the third step video data is received (Yes in S93), the control section 300 stores the received third step video data in the video memory 331 (S94). Then, the display control section 301 displays the third step video image corresponding to the third step video data stored in the video memory 331 in the display section 38 (S95). The third step video image is, for example, a video image for prompting or explaining a head indexing operation for conveying the paper to a predetermined position by operating the operation section 17 of the printer 1. Then, the control section 300 returns to S81.

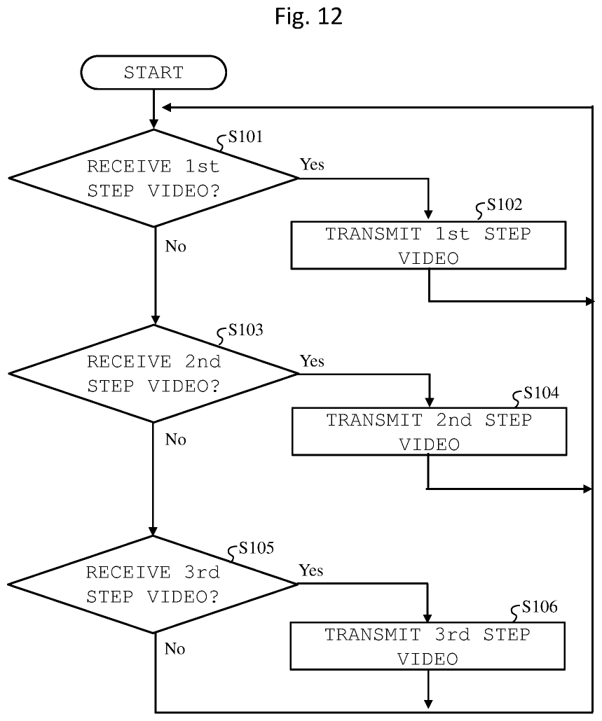

FIG. 12 is a flowchart showing a flow of control processing performed by the video server 5 according to the modification of the first embodiment. As shown in FIG. 12, the control section 500 of the video server 5 determines whether a signal requesting the distribution of first step video information related to the processing of S72 is received from the terminal 3 (S101). When it is determined that the signal requesting the first step video image information has been received (Yes in S101), the control section 500 extracts the first video data associated with the error number of the request (error number associated with the paper end signal) from the video data section 542, and transmits the first step video data to the terminal 3 (S102). Then, the control section 500 returns to S101.

When it is determined that the signal requesting the distribution of the first step video image information is not received (No in S101), the control section 500 then determines whether a signal requesting the distribution of the second step video information related to the processing in S82 is received from the terminal 3 (S 103). When it is determined that the signal requesting the distribution of the second step video image information is received (Yes in S103), the control section 500 extracts second step video data associated with the error number from the video data section 542, and transmits the extracted second step video data to the terminal 3 (S104). Then, the control section 500 returns to S101.

When it is determined that the signal requesting the distribution of the second step video image information is not received (No in S 103), the control section 500 determines whether a signal requesting the distribution of the third step video image information related to the processing in S92 is received from the terminal 3 (S105).

When it is determined that the signal requesting the distribution of the third step video image information is received (Yes in S105), the control section 500 extracts the third step video data associated with the error number from the video data section 542, and transmits the extracted third step video data to the terminal 3 (S106). Then, the control section 500 returns to S101.

As described above, according to the first embodiment and the modified example of the first embodiment, the video system 10 is a video distribution system and includes a printer 1 and a terminal 3. The printer 1 includes transmitter configured to transmit a step signal corresponding to potential errors that are pre-associated with instructional video images to the terminal 3. The terminal 3 includes a display 37, video memory 331 for storing video information corresponding to the potential errors of the printer 1 and a display controller for displaying video images for explaining steps or processes in the clearing of error signals of the printer 1. Therefore, each time the terminal 3 receives the stage signal from the printer 1, the terminal 2 displays a video image corresponding to the received stage signal. Therefore, a method for canceling an error can be displayed as a step-by-step video (stage-by-stage) without requiring a large-capacity memory to be provided in the printer 1 itself.

According to the first embodiment and the modification of the first embodiment, terminal 3 includes a display 37, a video memory 331 configured to store video data for storing video image information that indicates a procedure for clearing an error generated by the printer 1. The videos can be displayed in stages corresponding to the particular step in clearing one of a plurality of possible errors. The terminal 3 is configured for displaying a video image indicating the next procedure to be performed by an operator based on a signal received from the printer 1. Therefore, each time the terminal 3 receives a new stage signal from the printer 1, the terminal 3 can display the appropriate video image for the error clearing process stage corresponding to the received signal. Therefore, a procedure for clearing an error can be displayed to a user as a video image without mounting a large-capacity memory on the printer 1.

### Second Embodiment

The video system 10 in the first embodiment and the modified example includes a printer 1 and a terminal 3. In the second embodiment, the video system 20 includes a printer 1 and a video server 5.

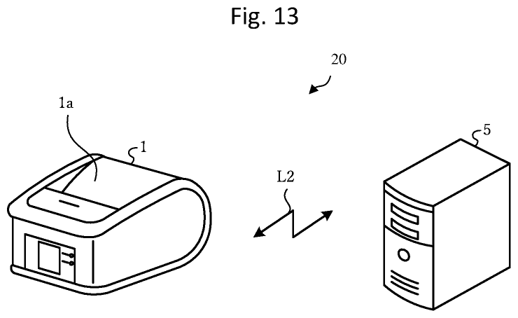

FIG. 13 is a diagram showing a video system 20 according to the second embodiment. As shown in FIG. 13, the video system 20 includes a printer 1 and a video server 5. The printer 1 and the video server 5 are connected to each other such that they can communicate with each other over a communication line L2 such as a wireless LAN (Local Area Network), for example.

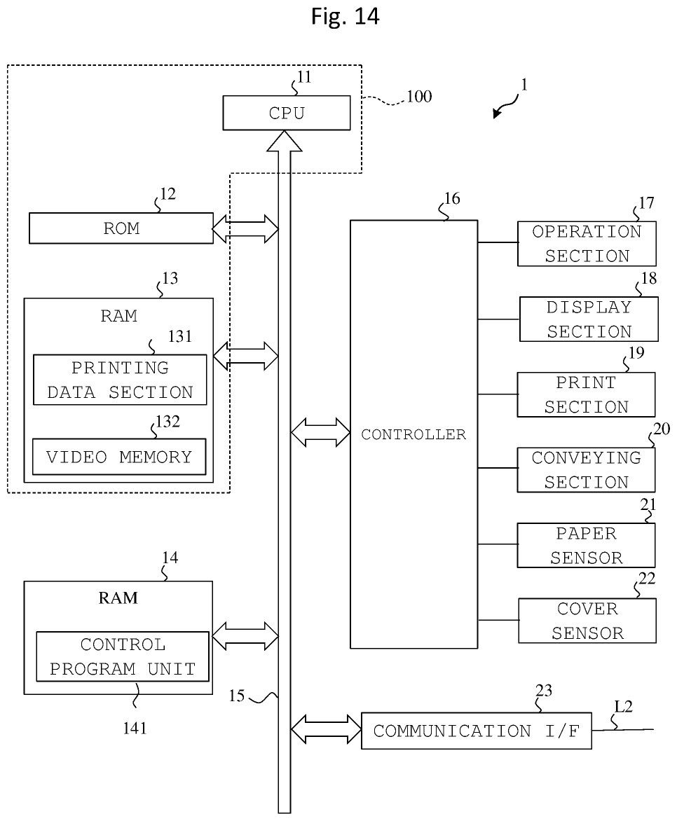

FIG. 14 is a block diagram showing a hardware configuration of the printer 1 according to the second embodiment. The printer 1 in the second embodiment is substantially the same as the structure shown in FIG. 2. However, in the second embodiment, the RAM 13 includes video memory 132. The video memory 132 stores video image information, which is received from the video server 5, and which shows the procedure of releasing the error generated in the printer 1 in stages corresponding to the release step. Also, the communication I/F 23 is connected to the communication line L2. The display section 18 is configured for displays video images based on the video image information stored in the video memory 132.

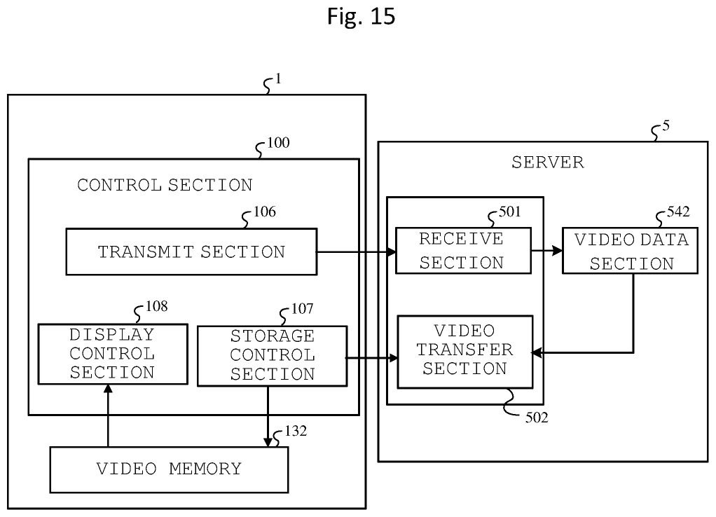

The functional configuration of the video system 20 according to the second embodiment will now be described. Specifically, the functional configuration of the printer 1 and the functional configuration of the video server 5 will be described. FIG. 15 is a functional block diagram of the video system 20. The control section 100 of the printer 1 can operate based on a control program (software) stored in the control program section 141. The control section 100 functions as a transmit section 106, a storage control section 107, and a display control section 108 by executing the control program stored in the RAM 13.

The transmit section 106 transmits an error signal (a signal requesting the display of a video image) to the video server 5 according to a step in the procedure for clearing the generated error. Specifically, when an error occurs in the printer 1, the transmit section 106 transmits an error signal indicating an error number indicating the type of error to the video server 5. Alternatively, the transmit section transmit a step signal indicating a current step in a procedure for clearing a particular error corresponding to the error number.

The storage control section 107 receives the video image information corresponding to the clearance procedure associated with the error signal and/or a step in the clearance procedure from the video server 5, and stores the video data in the video memory 132. Specifically, the storage control section 107 receives the video image information corresponding to the error signal and the current error clearance step, from the video server 5, and stores the video data in the video memory 132.

The display control section 108 displays the video images related to the video image information stored in the video memory 132.

The control section 500 (see FIG. 4) of the video server 5 provides the receive section 501 and the video transfer section 502 by executing a control program stored in the control program section 541 and then loaded in the RAM 53.

The receive section 501 determines which error number and/or the step signal has been received in the signal from the printer 1. For example, the signal from the printer 1 may indicate the paper roll end has been reached (paper end signal).

Each time the error signal and/or the step signal are received from the printer 1, the video transfer section 502 transmits corresponding video image information to the printer 1. Specifically, when an error signal is received from the printer 1, the video transfer section 502 transmits video image information indicating steps of the procedure for clearing an error corresponding to the error signal received from the printer 1. When the video transfer section 502 receives a step signal from the printer 1, the video transfer section 102 transmits video image information corresponding to a particular step in the procedure.

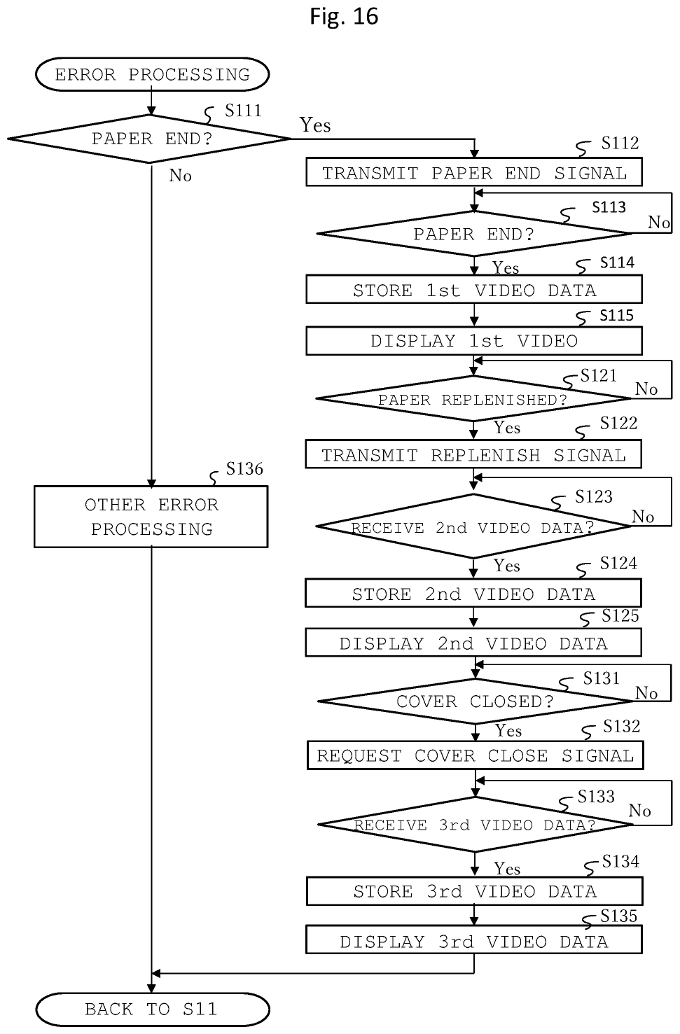

FIG. 16 is a flowchart of control processing of the printer relating to the error processing according to the second embodiment. In FIG. 16, a description will be given as an example of the processing for handling a paper end error received when the paper stored in the printer 1 has been exhausted. The control section 100 determines whether or not the error is a paper end error (S111). When it is determined that the error is a paper end error (Yes in S111), the transmit section 106 transmits a paper end signal (error signal) including the type of the error (error number) that has occurred and a signal requesting the distribution of the video data corresponding to the step(s) of clearing the error (S112) to the video server 5.

Next, the control section 100 determines whether or not the first video data has been received from the video server 5 (S113). When it is determined that the first video data is received (Yes in step S113), the storage control section 107 stores the first video data in the video memory 132 (S114). The display control section 108 then displays the first video image corresponding to the first video data stored in the video memory 132 (S115).

Next, the control section 100 determines whether or not the paper has been replenished for the printer 1 (S121). Once the paper has been replenished (Yes in S121), the transmit section 106 transmits a signal requesting the distribution of the paper replenishment signal and the additional video data (second video data) indicating the procedure for clearing the paper end error to the video server 5 (S122).

Next, the control section 100 determines whether the second video data has been received from the video server 5 (S123). Waiting after the second video data is received (No in S123) and when it is determined that the second video data has been received (Yes in S123), the storage control section 107 stores the second video data in the video memory 132 (S124). The display control section 108 displays the second video image corresponding to the second video data stored in the video memory 132 on the display section 18 (S125).

Next, the control section 100 determines whether or not the cover 1a has been closed (S131). When it is determined that the cover 1a is not closed (No in S131), then control section 100 waits (repeats S131) and when it is determined that the cover 1a is closed (Yes in S131), the transmit section 106 transmits a cover closing signal and a signal of a requesting the distribution of additional video data (third video data) indicating the procedure for clearing the paper end error to the video server 5 (S132).

Next, the control section 100 determines whether or not the third video data has been received from the video server 5 (step S133) When it is determined in step S133 that the third video data is not yet received (No in step S132), the control section repeats S132 and when it is determined that the third video data has been received, the storage control section 107 stores the third video data in the video memory 132 (S134). The third video data is then displayed (S135). Then, the control section 100 returns to S11 (see FIG. 7).

If it is determined in S111 that the error is not a paper end error (No in S111), the control section 100 executes error processing for other errors that have may have occurred (S136).

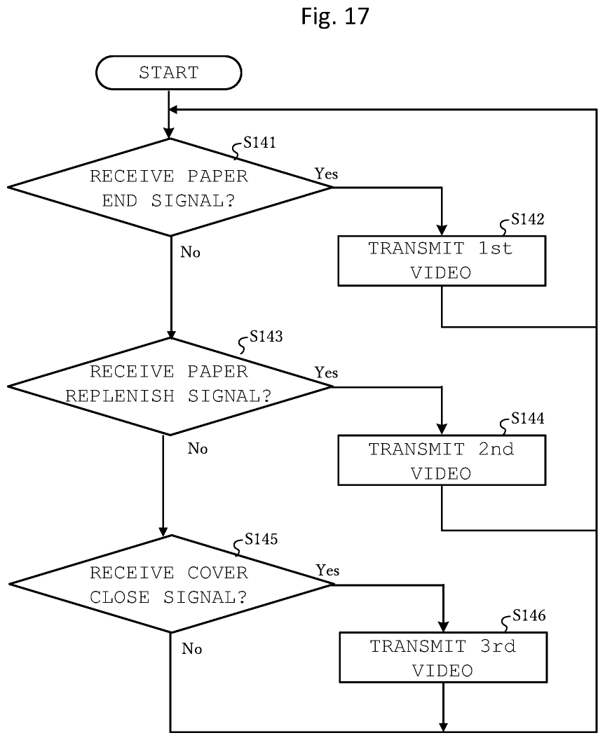

Next, the control of the video server 5 according to the second embodiment will be described. FIG. 17 is a flowchart of the control process performed by the video server 5 according to the second embodiment. As shown in FIG. 17, the receive section 501 of the video server 5 determines whether or not a paper end signal requesting the distribution the video data of the first stage related to the process in S112 has been received from the printer 1 (S141) When it is determined that the paper end signal requesting the distribution of the video data of the first stage has been received (Yes in S141), the video transfer section 502 extracts the first video data associated with the error number included in the paper end signal from the video data section 542, and transmits the first video data to the printer 1 (S142). Then, the control section 500 returns to S141.

When it is determined that the signal requesting the distribution of the first stage video data is not received (No in S141), the receive section 501 determines whether or not a paper replenishing signal requesting the distribution of the video data of the second stage has been received from the printer 1 (S143). When it is determined that of the sheet replenishment signal requesting the distribution the video image information of the second stage is received (Yes in S143), the video transfer section 502 extracts the second video data associated with the error number included in the sheet replenishment signal from the video data section 542, and transmits this data to the printer 1 (S144). Then, the control section 500 returns to S141.

When it is determined that the signal requesting the distribution of the video data in the second stage is not received (No in S141), the receive section 501 determines whether or not a cover closing signal requesting the distribution the third stage video data related to the processing in S132 has been received from the printer 1 (S145). When it is determined that the cover closing signal requesting the distribution of the third stage video data is received (Yes in S145), the video transfer section 502 extracts the third stage video data associated with the error number included in the cover closing signal from the video data section 542, and transmits the extracted third video data to the printer 1 (S146). Then, the control section 500 returns to S141.

According to the second embodiment, the video system 20 includes the printer 1 and the video server 5, the printer 1 includes video memory 132 and transmit section 106. The transmit section is configured for transmitting a signal for instructing the supply of the video data from the video server 5. The video data can be supplied from the video server 5 in a plurality of steps/stages corresponding to error clearance procedures associated with the original generated error. The video server 5 includes a video data section 542 storing video data configured for permitting the display section 18 of the printer 1 to display the video data transmitted in a step by step procedure for the error release process and a video transfer section 502 for transmitting the video data after receiving the step signal. The printer 1 includes a storage control section 107 (which may be referred to as a memory controller or the like) that stores the received video data in the video memory 132 and the display control section 108 (which may be referred to as a display controller or the like) to display the stored video image(s). Therefore, the printer 1 transmits, to the video server 5, a signal for instructing the display of the video image in a plurality of release steps corresponding to the generated error. The video server 5 stores the video image information corresponding to the error clearance procedure steps. The video transfer section 502 receives the video image information transmitted by the printer 1 Therefore, the printer 1 can display video images for clearing errors in a step-by-step manner and thus a large-capacity memory for video information/data is not required on the printer 1.

Various modifications of the above-described embodiments and examples are possible. For example, the printer 1 has been described as being compact and lightweight in the examples. However, the printer 1 is not limited to this, and may be a printer of any type.

The printer 1 is presented as an example of a device with moving parts (a motion device) which may be subject to occasional errors or failures in operations. The present disclosure is not limited to printers, and a device other than a printer may be adopted in other embodiments as long as it is a device that requires a correction processing of an error. The motion device may be referred to in some instances as portable device, a mobile device, or a mechanical device.

In addition, in the first embodiment and the modification example, the printer 1 and the terminal 3 are considered to be the video system 10. However, the present disclosure is not limited thereto. In other embodiments, the printer 1, the terminal 3, and the video server 5 may considered to be the video system 10.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed:

1. A video display system, comprising:
a first device generating first signals corresponding to an error state of the first device, each of the generated first signals indicating an error type of the error state and a stage in a predetermined operation for clearing the error state, wherein different first signals are generated at each stage in the predetermined operation;
a video image display screen to display video images related to the error state for each stage in the predetermined operation; and
a second device communicably connected to the first device to receive the first signals from the first device and sequentially supply the video images related to the error state to the video image display screen for each stage in the predetermined operation each time the first signal generated at one of the stages in the predetermined operation is received from the first device in an error condition.

2. The video display system according to claim 1, wherein the video image display screen is on the second device.

3. The video display system according to claim 1, wherein the video image display screen is on the first device.

4. The video display system according to claim 1, wherein the first device is a portable receipt printer, and
the portable receipt printer generates first signals related to the error state for each stage in the predetermined operation based on a detection output of a sensor mounted on the first device.

5. The video display system according to claim 1, wherein the second device is a smartphone.

6. The video display system according to claim 1, further comprising:
a third device communicably connected to the second device and configured to supply the video images related to the error state to the second device.

7. The video display system according to claim 6, wherein the third device is a video server communicably connected to the second device over the Internet.

8. The video display system according to claim 1, wherein
the second device is a video server, and
the video image display screen is on the first device.

9. The video display system according to claim 8, wherein
the first device includes a video storage memory for storing video images.

10. The video display system according to claim 9, wherein
the video storage memory has a size capable of storing video data only for a single stage at a time.

11. A terminal device for a video display system, the terminal device comprising:
a first communication interface for receiving error signals corresponding to an error state of a first device communicably connected to the first communication interface, the error signals identifying error types and stages in an operation for clearing the error state;
a video image display screen to display video images related to the error state; and
a processor configured to control the video image display screen to display video images related to the error state according to error type and stage in the operation for clearing the error state of the first device each time an error signal is received from the first device via the first communication interface.

12. The terminal device according to claim 11, further comprising:
a second communication interface for receiving the video images related to the error state from a video server.

13. The terminal device according to claim 12, wherein the processor is configured to request video images from the video server only one stage at a time in the predetermined operation to clear the error state.

14. The terminal device according to claim 11, further comprising:
a video storage unit storing video image data in association with error numbers corresponding to error types and stage numbers corresponding to each stage in the operation for clearing the error state.

15. A device with different possible error states, the device comprising:
a controller configured to generate signals corresponding to an error state of the device, the generated signals identifying error types and different stages in an operation for clearing the error state; and
a communication interface configured to transmit the signals generated by the controller.

16. The device according to claim 15, further comprising:
a video memory for storing a video image related to a stage in the operation of clearing the error state; and
a video image display screen, wherein
the controller is further configured to generate a signal requesting transmission of the video image related to each stage in the operation of clearing the error state one at a time from a second device.

17. The terminal device according to claim 15, wherein the controller is configured to request video images from a second device one stage at a time for the operation to clear the error state.

18. The device according to claim 15, further comprising:
a paper storage section for storing paper; and
a printer section for printing images on paper from the paper storage section.

19. The device according to claim 18, further comprising:
a cover for the paper storage section; and
a cover sensor for detecting a state of the cover.

20. The device according to claim 18, further comprising:
a paper sensor configured to detect a position of paper for the printer section.
